(19) United States
(12) Patent Application Publication
(10) Pub. No.: US 2015/0353820 A1
(43) Pub. Date: Dec. 10, 2015

(54) COMPOSITE GRANULES OF WHITE LIGHT QUANTUM DOTS, AND MANUFACTURE METHODS, MANUFACTURE DEVICES THEREOF

(71) Applicant: BOE TECHNOLOGY GROUP CO., LTD., Beijing (CN)

(72) Inventors: Chen TANG, Beijing (CN); Jingxia GU, Beijing (CN); Xuelan WANG, Beijing (CN)

(73) Assignee: BOE TECHNOLOGY GROUP CO., LTD., Beijing (CN)

(21) Appl. No.: 14/422,479

(22) PCT Filed: May 22, 2014
(86) PCT No.: PCT/CN2014/078090

§ 371 Date: Feb. 19, 2015

(30) Foreign Application Priority Data
Jan. 29, 2014 (CN) 201410043024.5

(51) Int. Cl. C09K 11/02; B01J 19/12; B01J 19/00

(52) U.S. Cl. CPC C09K 11/025; B01J 19/0093; B01J 19/123; B01J 2219/0869; B01J 2219/1203; B01J 2219/00889; B01J 2219/00894; B01J 2219/00936

(57) ABSTRACT

Composite granules of white light quantum dots and manufacture methods, manufacture devices thereof with improved stability and quantum efficiencies of quantum dots materials. The composite granules of white light quantum dots comprise: main body of the granules (1), which is a polymer obtained from light-polymerization of photoinitiator(s) and polymerizable component(s) under ultra-violet irradiation; red light quantum dots (2), green light quantum dots (3) and blue light quantum dots (4) dispersed in the main body of the granules, wherein the concentrations of the red light quantum dots (2), green light quantum dots (3) and blue light quantum dots (4) are different.

### TECHNICAL FIELD

Embodiments of the present invention relate to composite granules of white light quantum dots and manufacture methods, manufacture devices thereof.

### BACKGROUND

Organic light-emitting diodes (OLED) possess various advantages such as low cost, short response time, high brightness, wide view angle, low driving voltage, and flexible display. OLED technology has gained great progress in recent years, and has become full-color panel display technology with broad developing potential. As the performances of single-color OLED become increasingly mature, white organic light-emitting diodes (WOLED), a new kind of solid state light source, has gained extensive attention by exhibiting promising applications in various aspects e.g. in illumination and background light source for panel display. Its efficiencies and performances have been improved rapidly.

Quantum dots, also called semiconductor nano-crystals, belong to a new type of semiconductor nano materials. They possess unique photoluminescence and electroluminescence properties as a result of quantum size effects and dielectric confinement effects. Compared to traditional organic fluorescent dyes, quantum dots have excellent optical properties such as high quantum yield, high photochemical stability, anti-photolysis, broad-band excitation, narrow-band emission, high color purity, and a tunable color of emitted light through quantum dot size control. Various advantages such as high luminous efficiency, good stability, long service life, high brightness and broad color gamut can be obtained by manufacturing WOLED with quantum dots instead of small molecular organic materials. The following methods are ordinary methods of manufacturing white light sources with quantum dots.

For example, red, green and blue (R, G, B) quantum dots are mixed according to a certain ratio. There are several disadvantages of this method: the aggregation trend of R, G, B quantum dots leads to poor stability; it is hard to adjust the mixing ratio of quantum dots of the three colors; the emission spectrum of the obtained product is not stable; the emission light are not uniform, and the process is complicate.

For another example, fall color QD monitor can be produced in stamping or transfer printing fashion, wherein RGB arrays are formed from quantum dots utilizing impressions. However, the process of this method is complicate: impressions should be designed and produced; quantum dots materials should be processed into ink for printing; three times of transfer printing are needed for realization of color display; quantum dots tend to remain on the templates during transfer printing; the three colors tend to be mixed together; the resolution is low; and it is hard to realize mass production.

### SUMMARY

Some embodiments of the present invention provide composite granules of white light quantum dots and manufacture methods, manufacture devices thereof for solving the technical problems of poor stability and low quantum efficiency of quantum dots materials.

At least one embodiment of the present invention provides composite granules of white light quantum dots, which comprise: main body of the granules, which is a polymer obtained from light-polymerization of photoinitiator(s) and polymerizable component(s) under ultra-violet irradiation; and red light quantum dots, green light quantum dots and blue light quantum dots dispersed in the main body of the granules, wherein the concentrations of the red light quantum dots, the green light quantum dots and the blue light quantum dots are different.

At least one embodiment of the present invention provides a manufacture method for composite granules of white light quantum dots, which comprises: mixing photoinitiator(s), polymerizable component(s) and water with red light quantum dots, green light quantum dots or blue light quantum dots to form three solutions of quantum dots with different concentrations, i.e., a solution of red light quantum dots, a solution of green light quantum dots and a solution of blue light quantum dots; making an aqueous surfactant solution, wherein the surfactant concentration is inversely proportional to the diameter of the composite granules of white light quantum dots to be manufactured; providing the three solutions of quantum dots from three micro-fluid channels at a first velocity continuously, providing the aqueous surfactant solution from two external fluid channels at a second velocity continuously, directing the three solutions of quantum dots to outlets of the two external fluid channels after confluence at outlets of the three micro-fluid channels thereby mixing them to form droplets of white light quantum dots in the aqueous surfactant solution; and exporting the aqueous surfactant solution comprising the droplets of white light quantum dots out of a fluid exporting channel, and irradiating the fluid exporting channel with ultra-violet light to initiate the photo-polymerization reaction between the photoinitiator and polymerizable component(s) in the droplets of white light quantum dots so as to solidify the droplets of white light quantum dots to form the composite granules of white light quantum dots.

At least one embodiment of the present invention provides a manufacture device of composite granules of white light quantum dots, which comprises: a first micro-fluid channel, a second micro-fluid channel and a third micro-fluid channel; external fluid channel(s) comprising at least one branching channel; exporting channel(s); an ultra-violet light source for irradiating the droplets in the exporting channel(s) with ultra-violet. The outlets of all the branching channels of the external fluid channel(s) are interconnected to form the outlet of the external fluid channel(s); the outlets of said first micro-fluid channel, the second micro-fluid channel and the third micro-fluid channel are interconnected to form a mixture outlet; the mixture outlet and the outlet of the external fluid channel are interconnected, and the exporting channel(s) and the outlet of the external fluid channel are interconnected.

### BRIEF DESCRIPTION OF THE DRAWINGS

In order to more clearly explain the embodiments of the present invention, some drawings related to the embodiments of the invention will be briefly described. Apparently, the drawings described below merely involve some embodiments of the present invention, and should not be understood as limitations on the present invention.

FIG. 1 is a structurally schematic diagram of the composite granules of white light quantum dots provided by an embodiment of the present invention.

FIG. 2 is a structurally schematic diagram of part of a manufacture device for the composite granules of white light quantum dots provided by an embodiment of the present invention.

FIG. 3 is a structurally schematic diagram of a manufacture device for the composite granules of white light quantum dots provided by an embodiment of the present invention.

### DETAILED DESCRIPTION

The technical solutions of the embodiments will be described in detail in connection with the drawings related thereto. It should be noted that throughout the present specification, identical or similar labels represent identical or similar components or represent components possessing identical or similar functions. The embodiments described according to the drawings below are only illustrative. They should be understood only as illustration but not as limitations on the present invention.

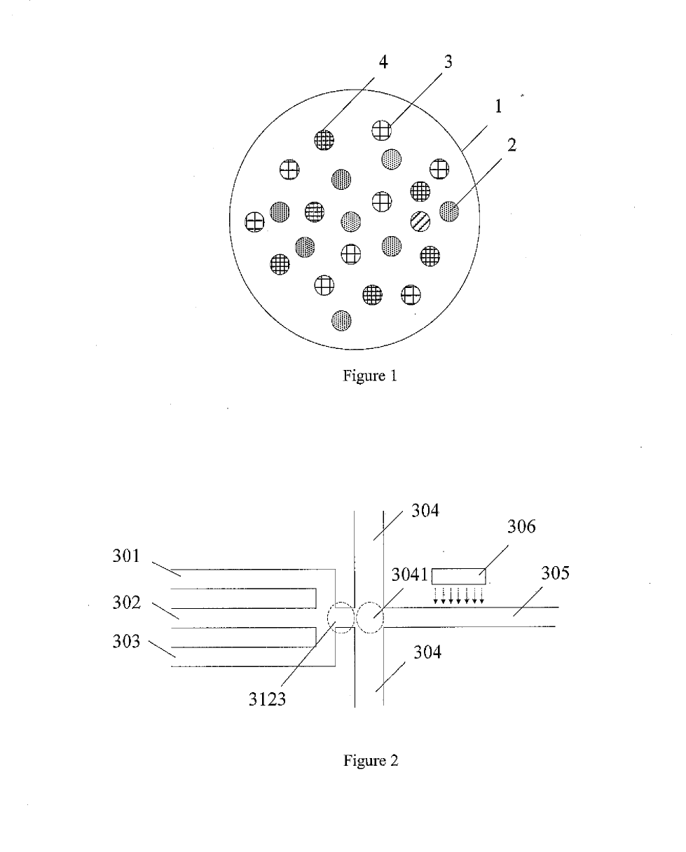

Refer to FIG. 1, at least one embodiment of the present invention provides composite granules of white light quantum dots, which comprise: main body of the granules 1 and red light quantum dots 2, green light quantum dots 3 and blue light quantum dots 4 dispersed in the main body of the granules.

The main body of the granules 1 is a polymer obtained from light-polymerization of photoinitiator(s) and polymerizable component(s) under ultra-violet irradiation; the concentrations (e.g. mass or volume percentages) of the red light quantum dots 2, green light quantum dots 3 and blue light quantum dots 4 dispersed in the main body of the granules are different.

In the present embodiment, composite granules of white light quantum dots are formed by quantum dots of the three primary colors which exist in polymer granules. In this case, the quantum dots of the three primary colors are not easy to aggregate.

For example, the ratio between the red light quantum dots, the green light quantum dots and the blue light quantum dots may be about 0.5˜0.8:1:1.5˜1.2. For another example, the ratio between the red light quantum dots, the green light quantum dots and the blue light quantum dots may be adjusted to about 0.65˜0.74:1:1.35˜1.25 to obtain better white light.

In certain embodiments of the present invention, the ratio between quantum dots of different colors has been selected to further improve the quality of the composite granules. With regard to the ratio between the red light quantum dots, the green light quantum dots and the blue light quantum dots, for example if the red light quantum dots weight 5% of the composite granules of white light quantum dots, the green light quantum dots weight 10% of the composite granules of white light quantum dots, and the blue light quantum dots weight 15% of the composite granules of white light quantum dots, the ratio between the three in the composite granules of white light quantum dots is 0.5:1:1.5.

For example, the emission wavelength range of the red light quantum dots may be about 600-685 nm, the emission wavelength range of the green light quantum dots may be about 520-580 nm, and the emission wavelength range of the blue light quantum dots is about 425-485 nm. For example, the emission wavelength of the red light quantum dots is about 613 nm, the emission wavelength of the green light quantum dots is about 555 nm, and the emission wavelength of the blue light quantum dots is about 452 nm.

In certain embodiments of the present invention, the emission wavelengths of the quantum dots of different colors have been selected to further improve the quality of the composite granules, including more stable emission spectra and more uniform light.

For example, the polymerizable components may include 3-methacryloxypropyldimethylchlorosilane, pentaerythritol triacrylate, trimethylolpropane triacrylate, pentaerythritol tetraacrylate, dipropylene glycol diacrylate, tripropylene glycol diacrylate, hexanediol diacrylate, neopentyl glycol diacrylate, hydroxyethyl methacrylate, hydroxypropyl methacrylate, or combinations thereof.

For example, the photoinitiator includes 1-hydroxycyclohexyl phenyl ketone, 2-hydroxy-2-methylpropiophenone, 2-methyl-1-[4-(methylthio)phenyl]-2-morpholino-1-propanone, or 2,2-diethoxyacetophenone, or combinations thereof.

The beneficial effects of at least one embodiment of the present invention include: because the red, green and blue light quantum dots are confined in a spherical space, aggregation hardly occurs between quantum dots materials and high stability and high quantum efficiency can be obtained; the manufacture method for composite granules of the quantum dots is simple and mass production can be easily realized.

At least one embodiment of the present invention provides a manufacture method for composite granules of white light quantum dots, which can be carried out as follows.

Step 101, mixing photoinitiator(s), polymerizable component(s) and water with red light quantum dots, green light quantum dots or blue light quantum dots to form three solutions of quantum dots with different concentrations, which are a solution of red light quantum dots, a solution of green light quantum dots and a solution of blue light quantum dots.

Step 102, making an aqueous surfactant solution wherein the concentration of the surfactant in the aqueous solution is inversely proportional to the diameter of the composite granules of white light quantum dots to be manufactured.

Step 103, providing the three solutions of quantum dots from three micro-fluid channels at a first velocity continuously, providing the aqueous surfactant solution from two external fluid channels at a second velocity continuously, directing the three solutions of quantum dots to outlets of the two external fluid channels after confluence at outlets of the three micro-fluid channels, thereby mixing them to form droplets of white light quantum dots in the aqueous surfactant solution.

Step 104, exporting the droplets of white light quantum dots and the aqueous surfactant solution from a fluid exporting channel, and irradiating the fluid exporting channel with ultra-violet light to initiate the photo-polymerization reaction between the photoinitiator and the polymerizable component(s) in the droplets of white light quantum dots, so as to solidify the droplets of white light quantum dots to form the composite granules of white light quantum dots.

For example, the red light quantum dots may weight about 1-60% of the solution of the red light quantum dots, the green light quantum dots may weight about 1-60% of the solution of the green light quantum dots, and the blue light quantum dots may weight about 1-60% of the solution of the blue light quantum dots. For another example, the red light quantum dots may weight about 10-30% of the solution of the red light quantum dots, the green light quantum dots may weight about 10-30% of the solution of the green light quantum dots, and the blue light quantum dots may weight about 10-30% of the solution of the blue light quantum clots.

In certain embodiments of the present invention, the mass percentages of the quantum dots in their respective solutions have been selected to further improve the quality of the composite granules.

For example, the emission wavelength range of the red light quantum dots may be about 600-685 nm, the emission wavelength range of the green light quantum dots may be about 520-580 nm, and the emission wavelength range of the blue light quantum dots may be about 425-485 nm. For another example, the emission wavelength of the red light quantum dots is about 613 nm, the emission wavelength of the green light quantum dots is about 555 nm, and the emission wavelength of the blue light quantum dots is about 452 nm.

In certain embodiments of the present invention, the emission wavelengths of the quantum dots of different colors have been selected to further improve the quality of the composite granules, including more stable emission spectra and more uniform light.

For example, the mass percentages of the polymerizable component(s) in the solutions of the red light quantum dots, the green light quantum dots or the blue light quantum dots may be about 50-98%.

In certain embodiments of the present invention, the mass percentages of the polymerizable component(s) in the solutions of the red light quantum dots, the green light quantum dots or the blue light quantum dots have been selected to further improve the quality of the composite granules.

For example, the polymerizable component(s) may include 3-methacryloxypropyldimethylchlorosilane, pentaerythritol triacrylate, trimethylolpropane triacrylate, pentaerythritol tetraacrylate (PET4A), dipropylene glycol diacrylate, tripropylene glycol diacrylate, hexanediol diacrylate, neopentyl glycol diacrylate, hydroxyethyl methacrylate, hydroxypropyl methacrylate or combinations thereof.

For example, the mass percentage of the photoinitiator in the solutions of the red light quantum dots, the green light quantum dots or the blue light quantum dots is about 1-10%.

In certain embodiments of the present invention, the mass percentages of the photoinitiator in the solutions of the red light quantum dots, the green light quantum dots or the blue light quantum dots have been selected to further improve the quality of the composite granules.

For example, the photoinitiator may include 1-hydroxycyclohexyl phenyl ketone, 2-hydroxy-2-methylpropiophenone, 2-methyl-1-[4-(methylthio)phenyl]-2-morpholino-1-propanone or 2,2-diethoxyacetophenone or combinations thereof.

For example, the first velocity ranges between about 0.5 milliliter/hour (ml/hr) and about 2 ml/hr, and the second velocity ranges between about 2 ml/hr and about 10 ml/hr.

In certain embodiments of the present invention, the ranges of the first velocity and the second velocity have been selected to further improve controllability of the manufacture process.

The beneficial effects of at least one embodiment of the present invention include: because the red, green and blue light quantum dots are confined in a spherical space, aggregation hardly occurs between quantum dots materials and high stability and high quantum efficiency can be obtained; the manufacture method for composite granules of the quantum dots is simple and mass production can be easily realized.

The technical solutions of the embodiments of the present invention will be described in detail through the following examples.

### Example 1

First, making solutions of quantum dots of the three primary colors. For example: regarding the solution of red light quantum dots, the mass percentage of the red light quantum dots was 1%; the mass percentage of the monomer 3-methacryloxypropyldimethylchlorosilane was 91% and the mass percentage of the photoinitiator 1-hydroxycyclohexyl phenyl ketone was 8%; regarding the solution of green light quantum dots, the mass percentage of the green light quantum dots was 3%, the mass percentage of the monomer 3-methacryloxypropyldimethylchlorosilane was 90% and the mass percentage of the photoinitiator 1-hydroxycyclohexyl phenyl ketone was 7%; regarding the solution of blue light quantum dots, the mass percentage of the blue light quantum dots was 15%, the mass percentage of the monomer 3-methacryloxypropyldimethylchlorosilane was 79% and the mass percentage of the photoinitiator 1-hydroxycyclohexyl phenyl ketone was 6%.

Second, making the aqueous surfactant solution. For example, the mass percentage of the surfactant sodium dodecyl sulfonate (SDS) was 1%.

Third, providing the three solutions of quantum dots from three micro-fluid channels at a velocity of 0.5 ml/hr continuously, providing the aqueous surfactant solution from two external fluid channels at a velocity of 2.2 ml/hr continuously, directing the three solutions of quantum dots to outlets of the two external fluid channels after confluence at outlets of the three micro-fluid channels, thereby forming droplets of the white light quantum dots by the mixture of the three solutions of quantum dots in the aqueous surfactant solution.

Next, exporting the droplets of the white light quantum dots and the aqueous surfactant solution out of a fluid exporting channel, irradiating the fluid exporting channel with ultra-violet light to initiate the photo-polymerization reaction between the photoinitiator and the polymerizable component in the droplets of white light quantum dots, so as to solidify the droplets of white light quantum dots to form composite granules of white light quantum dots.

### Example 2

First, making solutions of quantum dots of the three primary colors. For example: regarding the solution of red light quantum dots, the mass percentage of the red light quantum dots was 1%; the mass percentage of the monomer 3-methacryloxypropyldimethylchlorosilane was 91% and the mass percentage of the photoinitiator 1-hydroxycyclohexyl phenyl ketone was 8%; regarding the solution of green light quantum dots, the mass percentage of the green light quantum dots was 3%, the mass percentage of the monomer 3-methacryloxypropyldimethylchlorosilane was 90% and the mass percentage of the photoinitiator 1-hydroxycyclohexyl phenyl ketone was 7%; regarding the solution of blue light quantum dots, the mass percentage of the blue light quantum dots was 15%, the mass percentage of the monomer 3-methacryloxypropyldimethylchlorosilane was 79% and the mass percentage of the photoinitiator 1-hydroxycyclohexyl phenyl ketone was 6%.

Second, making the aqueous surfactant solution. For example, the mass percentage of the surfactant sodium dodecyl sulfonate (SDS) was 1.2%.

Third, providing the three solutions of quantum dots from three micro-fluid channels at a velocity of 0.6 ml/hr continuously, providing the aqueous surfactant solution from two external fluid channels at a velocity of 2.2 ml/hr continuously, directing the three solutions of quantum dots to outlets of the two external fluid channels after confluence at outlets of the three micro-fluid channels, thereby forming droplets of the white light quantum dots by the mixture of the three solutions of quantum dots in the aqueous surfactant solution.

Next, exporting the droplets of the white light quantum dots and the aqueous surfactant solution out of a fluid exporting channel, irradiating the fluid exporting channel with ultra-violet light to initiate the photo-polymerization reaction between the photoinitiator and the polymerizable component in the droplets of white light quantum dots, so as to solidify the droplets of white light quantum dots to form composite granules of white light quantum dots.

### Example 3

First, making solutions of quantum dots of the three primary colors. For example: regarding the solution of red light quantum dots, the mass percentage of the red light quantum dots was 12%; the mass percentage of the monomer 3-methacryloxypropyldimethylchlorosilane was 85% and the mass percentage of the photoinitiator 1-hydroxycyclohexyl phenyl ketone was 3%; regarding the solution of green light quantum dots, the mass percentage of the green light quantum dots was 15.3%, the mass percentage of the monomer 3-methacryloxypropyldimethylchlorosilane was 82% and the mass percentage of the photoinitiator 1-hydroxycyclohexyl phenyl ketone was 2.7%; regarding the solution of blue light quantum dots, the mass percentage of the blue light quantum dots was 22.3%, the mass percentage of the monomer 3-methacryloxypropyldimethylchlorosilane was 70% and the mass percentage of the photoinitiator 1-hydroxycyclohexyl phenyl ketone was 7.7%.

Second, making the aqueous surfactant solution. For example, the mass percentage of the surfactant sodium dodecyl sulfonate (SDS) was 1%.

Third, providing the three solutions of quantum dots from three micro-fluid channels at a velocity of 0.5 ml/hr continuously, providing the aqueous surfactant solution from two external fluid channels at a velocity of 2 ml/hr continuously, directing the three solutions of quantum dots to outlets of the two external fluid channels after confluence at outlets of the three micro-fluid channels, thereby forming droplets of the white light quantum dots by the mixture of the three solutions of quantum dots in the aqueous surfactant solution.

Next, exporting the droplets of the white light quantum dots and the aqueous surfactant solution out of a fluid exporting channel, irradiating the fluid exporting channel with ultra-violet light to initiate the photo-polymerization reaction between the photoinitiator and the polymerizable component in the droplets of white light quantum dots, so as to solidify the droplets of white light quantum dots to form composite granules of white light quantum dots.

The above examples only involve some embodiments. They should be understood only as illustration but not as limitations on the present invention.

For example, the above examples may be carried out utilizing a manufacture device for the composite granules of white light quantum dots illustrated in FIG. 2, which comprises: a first micro-fluid channel 301, a second micro-fluid channel 302, a third micro-fluid channel 303, an external fluid channel 304, an exporting channel 305 and an ultra-violet light source 306.

The first micro-fluid channel 301, the second micro-fluid channel 302 and the third micro-fluid channel 303 are utilized to transport the solution of red light quantum dots, the solution of green light quantum dots and the solution of blue light quantum dots, respectively. Each micro-fluid channel is utilized to transport one solution of quantum dots, and each solution of quantum dots comprises photoinitiator(s) and polymeriable component(s). For example, the first micro-fluid channel 301 is utilized to transport the solution of red light quantum dots, the second micro-fluid channel 302 is utilized to transport the solution of green light quantum dots and the third micro-fluid channel 303 is utilized to transport the solution of blue light quantum dots. Of course, the first micro-fluid channel 301 may be utilized to transport the solution of blue light quantum dots, the second micro-fluid channel 302 may be utilized to transport the solution of red light quantum dots, and the third micro-fluid channel 303 may be utilized to transport the solution of green light quantum dots. Each micro-fluid channel may be utilized to transport a certain solution of quantum dots according to the actual situation, but it does not mean that it must transport the certain solution of quantum dots.

The external fluid channel 304 may comprise at least one branching channel, for example two or three branching channels. The external fluid channel 304 is utilized to transport the aqueous surfactant solution.

The exporting channel 305 is utilized to transport the droplets of white light quantum dots and the aqueous surfactant solution.

The ultra-violet light source 306 is utilized for irradiating the droplets of white light quantum dots in the exporting channel 305 with ultra-violet light, thereby manufacturing composite granules of white light quantum dots through initiating the photo-polymerization reaction between the photoinitiator and polymerizable component(s) in the droplets of white light quantum dots.

The outlets of all the branching channels of the external fluid channel 304 are interconnected to form an outlet 3041 of the external fluid channels 304; the outlets of the first micro-fluid channel 301, the second micro-fluid channel 302 and the third micro-fluid channel 303 are interconnected to form an outlet 3123 of a mixture solution of quantum dots; the outlet 3123 of the mixture solution of quantum dots and the outlet 3041 of the external fluid channel 304 are interconnected, and the outlet 3041 of the external fluid channel 304 and the exporting channel 305 of the manufacture device are interconnected.

The solution of red light quantum dots, the solution of green light quantum dots and the solution of blue light quantum dots which are transported from the first micro-fluid channel 301, the second micro-fluid channel 302 and the third micro-fluid channel 303, respectively, are mixed to form a mixture solution at the outlet 3123 of mixture solution of quantum dots. The mixture solution is transported from the outlet 3123 of mixture solution of quantum dots to the outlet 3041 of the external fluid channel 304. Under the influence of the surfactant in the aqueous surfactant solution, droplets of white light quantum dots are formed and exported out of the exporting channel 305.

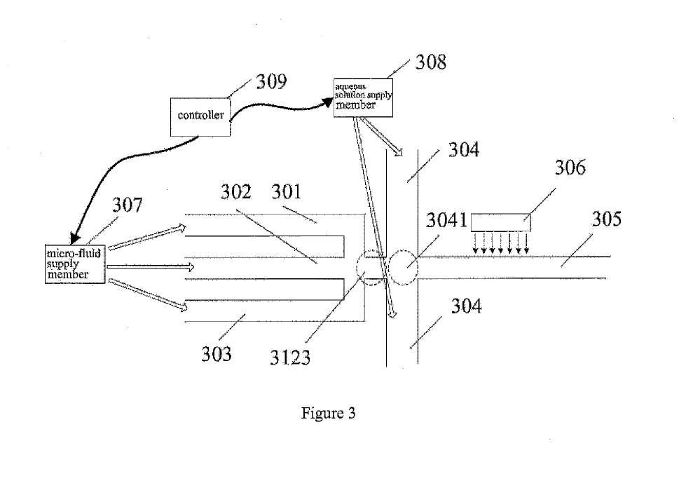

As shown in FIG. 3, in at least one embodiment of the present invention, on the basis of the manufacture device shown in FIG. 2, in order to transport each solution of quantum dots through respective micro-fluid channel at a desired velocity, additionally provided is a micro-fluid supply member 307, which is connected to each inlet of all the micro-fluid channels. In order to transport the aqueous surfactant solution through the external fluid channel 304 at a desired velocity, additionally provided is an aqueous solution supply member 308, which is connected to each inlet of all the branching channels of the external fluid channel 304. Pumps may be used both in the micro-fluid supply member 307 and the aqueous solution supply member 308. It should be explained that, the micro-fluid supply member 307 and the aqueous solution supply member 308 may either be disposed independently, or may be combined as one fluid supply member. In at least one embodiment of the present invention, additionally provided is a control member 309, which is utilized to control the micro-fluid supply member 307 and the aqueous solution supply member 308 to supply fluids at a desired velocity.

The beneficial effects of at least one embodiment of the present invention include: three micro-fluid channels and at least one external fluid channel are provided to from droplets of white light quantum dots through mixing the solution of red light quantum dots, the solution of green light quantum dots and the solution of blue light quantum dots at a desired velocity, and composite granules of white light quantum dots are further formed by ultra-violet irradiation. Since the red, green and blue light quantum dots are confined in a spherical space by the composite granules of white light quantum dots, aggregation hardly occurs between quantum dots materials, and high stability and high quantum efficiency can be obtained; the manufacture method for composite granules of the quantum dots is simple and mass production can be easily realized.

Apparently, those skilled in the art can modify or change the present invention without departing from the spirit and scope of the invention. Thus, if such modifications or changes of the present invention belong to the scope of the claims of the present invention or the scope of equivalent technique thereof, they are intended to be encompassed by the present invention.

The present application claims the benefits of the Chinese Application No. 201410043024.5 filed on Jan. 29, 2014, the entire disclosure of which is incorporated herein by reference.

1. Composite granules of white light quantum dots, which comprise:
main body of the granules which is a polymer obtained from light-polymerization of photoinitiator(s) and polymerizable component(s) under ultra-violet irradiation; and
red light quantum dots, green light quantum dots and blue light quantum dots dispersed in the main body of the granules, wherein the concentrations of the red light quantum dots, the green light quantum dots and the blue light quantum dots are different.

2. The composite granules of white light quantum dots according to claim 1, wherein,
the ratio between the red light quantum dots, the green light quantum dots and the blue light quantum dots is about 0.5˜0.8:1:1.5˜1.2.

3. The composite granules of white light quantum dots according to claim 2, wherein,
the ratio between the red light quantum dots, the green light quantum dots and the blue light quantum dots is about 0.65˜0.74:1:1.35˜1.25.

4. The composite granules of white light quantum dots according to claim 1, wherein,
the emission wavelength range of the red light quantum dots is from about 600 to about 685 nm; the emission wavelength range of the green light quantum dots is from about 520 to about 580 nm; and the emission wavelength range of the blue light quantum dots is from about 425 to about 485 nm.

5. The composite granules of white light quantum dots according to claim 4, wherein,
the emission wavelength of the red light quantum dots is about 613 nm; the emission wavelength of the green light quantum dots is about 555 nm; and the emission wavelength of the blue light quantum dots is about 452 nm.

6. The composite granules of white light quantum dots according to claim 1, wherein,
the polymerizable component(s) include 3-methacryloxypropyldimethylchlorosilane, pentaerythritol triacrylate, trimethylolpropane triacrylate, pentaerythritol tetraacrylate, dipropylene glycol diacrylate, tripropylene glycol diacrylate, hexanediol diacrylate, neopentyl glycol diacrylate, hydroxyethyl methacrylate, hydroxypropyl methacrylate, or combinations thereof.

7. The composite granules of white light quantum dots according to claim 1, wherein,
the photoinitiator includes 1-hydroxycyclohexyl phenyl ketone, 2-hydroxy-2-methylpropiophenone, 2-methyl-1-[4-(methylthio)phenyl]-2-morpholino-1-propanone, 2,2-diethoxyacetophenone, or combinations thereof.

8. A manufacture method for composite granules of white light quantum dots, which comprises:
mixing photoinitiator(s), polymerizable component(s) and water with red light quantum dots, green light quantum dots or blue light quantum dots to form a solution of red light quantum dots, a solution of green light quantum dots and a solution of blue light quantum dots with different concentrations respectively;
making an aqueous surfactant solution wherein the surfactant concentration is inversely proportional to the diameter of the composite granules of white light quantum dots to be manufactured;
providing the three solutions of quantum dots from three micro-fluid channels at a first velocity continuously, providing the aqueous surfactant solution from two external fluid channels at a second velocity continuously, and then directing the three solutions of quantum dots to outlets of the two external fluid channels after confluence at outlets of the three micro-fluid channels thereby mixing them to form droplets of white light quantum dots in the aqueous surfactant solution; and
exporting the aqueous surfactant solution comprising the droplets of white light quantum dots out of a fluid exporting channel and irradiating the fluid exporting channel with ultra-violet light to initiate the photo-polymerization reaction between the photoinitiator and polymerizable component(s) in the droplets of white light quantum dots so as to solidify the droplets of white light quantum dots to form the composite granules of white light quantum dots.

9. The manufacture method according to claim 8, wherein, the weight percentage of the red light quantum dots in the solution of the red light quantum dots is about 1-60%; the weight percentage of the green light quantum dots in the solution of the green light quantum dots is about 1-60%; and the weight percentage of the blue light quantum dots in the solution of the blue light quantum dots is about 1-60%.

10. The manufacture method according to claim 9, wherein, the weight percentage of the red light quantum dots in the solution of the red light quantum dots is about 10-30%; the weight percentage of the green light quantum dots in the solution of the green light quantum dots is about 10-30%; and the weight percentage of the blue light quantum dots in the solution of the blue light quantum dots is about 10-30%.

11. The manufacture method according to claim 8, wherein,
the emission wavelength range of the red light quantum dots is from about 600 to about 685 nm; the emission wavelength range of the green light quantum dots is from about 520 to about 580 nm; and the emission wavelength range of the blue light quantum dots is from about 425 to about 485 nm.

12. The manufacture method according to claim 11, wherein,
the emission wavelength of the red light quantum dots is about 613 nm; the emission wavelength of the green light quantum dots is about 555 nm; and the emission wavelength of the blue light quantum dots is about 452 nm.

13. The manufacture method according to claim 8, wherein, the mass percentage of the polymerizable component(s) in the solution of the red light quantum dots, the solution of the green light quantum dots or the solution of the blue light quantum dots is about 50-98%.

14. The manufacture method according to claim 13, wherein, the polymerizable component(s) include 3-methacryloxypropyldimethylchlorosilane, pentaerythritol triacrylate, trimethylolpropane triacrylate, pentaerythritol tetraacrylate, dipropylene glycol diacrylate, tripropylene glycol diacrylate, hexanediol diacrylate, neopentyl glycol diacrylate, hydroxyethyl methacrylate, hydroxypropyl methacrylate or combinations thereof.

15. The manufacture method according to claim 8, wherein, the mass percentage of the photoinitiator in the solution of the red light quantum dots, the solution of the green light quantum dots or the solution of the blue light quantum dots is about 1-10%.

16. The manufacture method according to claim 15, wherein, the photoinitiator includes 1-hydroxycyclohexyl phenyl ketone, 2-hydroxy-2-methylpropiophenone, 2-methyl-1-[4-(methylthio)phenyl]-2-morpholino-1-propanone 2,2-diethoxyacetophenone, or combinations thereof.

17. The manufacture method according to claim 8, wherein, the first velocity ranges from about 0.5 ml/hr to about 2 ml/hr, and the second velocity ranges from about 2 ml/hr to about 10 ml/hr.

18. A manufacture device of composite granules of white light quantum dots, which comprises:
a first micro-fluid channel, a second micro-fluid channel and a third micro-fluid channel;
external fluid channel(s) comprising at least one branching channel;
exporting channel(s);
an ultra-violet light source for irradiating the droplets in the exporting channel(s) with ultra-violet light; and
wherein, outlets of all the branching channels of the external fluid channel(s) are interconnected to form an outlet of the external fluid channel(s); the outlets of the first micro-fluid channel, the second micro-fluid channel and the third micro-fluid channel are interconnected to form a mixture outlet; the mixture outlet and the outlet of the external fluid channel(s) are interconnected, and the exporting channel(s) and the outlet of the external fluid channel(s) are interconnected.

19. The manufacture device according to claim 18, further comprising,
a micro-fluid supply member interconnected with the inlets of the first micro-fluid channel, the second micro-fluid channel and the third micro-fluid channel; and
an aqueous solution supply member interconnected with the inlets of each branching channel of the external fluid channels.
